(19) United States
(12) Patent Application Publication
(10) Pub. No.: US 2020/0215538 A1
(43) Pub. Date: Jul. 9, 2020

(54) SELF-DRIVEN MICROFLUIDIC CHIP FOR RAPID INFLUENZA A DETECTION

(71) Applicant: NATIONAL TSING HUA UNIVERSITY, HSINCHU (TW)

(72) Inventors: GWO-BIN LEE, HSINCHU CITY (TW); YU-DONG MA, TAOYUAN CITY (TW); HSI-PIN MA, HSINCHU (TW); PO-CHIUN HUANG, HSINCHU (TW); KUANG-HSIEN LI, TAIPEI CITY (TW); YI-HONG CHEN, TAICHUNG CITY (TW); YUNG-MAO LEE, YUNLIN COUNTY (TW)

(21) Appl. No.: 16/394,980

(22) Filed: Apr. 25, 2019

(30) Foreign Application Priority Data
Jan. 4, 2019 (TW) 108100409

(51) Int. Cl. B01L 3/00

(52) U.S. Cl. CPC B01L 3/50273; B01L 2400/0406; B01L 2300/165; B01L 2200/10; B01L 2300/123; B01L 2400/0633; B01L 2300/0861

(57) ABSTRACT

A self-driven microfluidic chip for rapid influenza A detection is provided. The chip includes: a substrate, a hydrophobic layer, a hydrophilic film layer, and a channel structure layer laminated sequentially. The structure of the channel structure layer includes a plurality of channels, a plurality of valves and reaction chambers in the channels, and a plurality of openings, wherein the hydrophilic film layer includes a pattern corresponding to the structure of the channel structure layer, and forms a disconnected area corresponding to the location of the valves to make the valves hydrophobic; the channel structure layer is formed of a flexible material, and heights of the valves are higher than those of the channels in a thickness direction of the channel structure layer in order to control liquid flow by pressing the valves.

### CROSS-REFERENCE TO RELATED APPLICATION

This application claims priority from Taiwan Patent Application No. 108100409, filed on Jan. 04, 2019, Taiwan Intellectual Property Office, the contents of which are hereby incorporated by reference in their entirety for all purposes.

### BACKGROUND

### 1. Technical Field

The present invention relates to a self-driven microfluidic chip for rapid influenza A detection, and more particularly to a self-driven microfluidic chip which is able to be self-driven in a predetermined channel by the capillary action and able to control the liquid flow process by a soft hydrophobic valve.

### 2. Description of the Related Art

Influenza is an infectious disease of acute upper respiratory tract infection caused by influenza virus, and it may be classified into four types (A, B, C and D) due to different proteins on the surface of the virus. Of these types, the H1N1 in influenza A virus is the most harmful to humans, and often occurs periodically worldwide, causing countless patient deaths.

The patients of influenza A are mainly old people and children, but recently, the number of patients infected with influenza A in middle-aged adults has increased. If they are not treated in time, serious complications may result (such as pneumonia or cardiopulmonary failure), and the death rate moves closer to 20%. Therefore, the development of the rapid and accurate H1N1 diagnosis has become an important issue in order to process the early treatment and reduce the incidence rate of serious complications.

Traditional methods for detecting influenza virus infection include virus culture, immunological detection, and Reverse Transcriptase-Polymerase Chain Reaction (RT-PCR), but these detection methods have disadvantages such as being time consuming, complicated, having low sensitivity, and needing expensive equipment. On the other hand, rapid influenza diagnostic test chips commonly used in clinics using colloidal gold immunoassay are relatively simple in operation. The test results may be obtained in only 15 to 20 minutes; however in relatively, the accuracy is not high (about 50-70%). It is easy to be affected by the virus activity and the amount of virus in the sample, so as to cause the false negative phenomenon. Accordingly, it still needs to be diagnosed by the doctor or wait for the results obtained by RT-PCR to confirm the results in order to carry on the follow-up treatment. Therefore, there is still a need to develop a rapid and highly sensitive detecting method for detecting H1N1.

### SUMMARY

In view of the above known problems, the purpose of the present invention is to provide a self-driven microfluidic chip for rapid influenza A detection. The present invention utilizes the chip to purify and separate the virus, and then uses the isothermal nucleic acid amplification method to amplify the nucleic acid. The color changes before and after the reaction of the magnesium ion indicator may be used to confirm the result through the naked eye or the optical sensor. A self-driven microfluidic chip for rapid influenza A detection includes: a substrate; a hydrophobic layer disposed on the substrate; a hydrophilic film layer disposed on the hydrophobic layer; and a channel structure layer disposed on the hydrophilic film layer, a structure of the channel structure layer including a plurality of channels, a plurality of valves disposed in the plurality of channels, a plurality of reaction chambers and a plurality of openings; wherein the hydrophilic film layer has a pattern corresponding to the structure of the channel structure layer, and forms a disconnected area corresponding to locations of the plurality of valves to make the plurality of valves hydrophobic, and the channel structure layer is formed of a flexible material, and heights of the plurality of valves are higher than those of the plurality of channels in a thickness direction of the channel structure layer in order to control liquid flow by pressing the plurality of valves.

Preferably, the structure of the channel structure layer is further divided into a sample pretreatment region for purifying and lysing virus in a sample, and a nucleic acid amplification reaction region for nucleic acid amplification by an isothermal nucleic acid amplification method.

Preferably, the sample pretreatment region includes: a pretreatment reaction chamber; a plurality of liquid injection channels respectively having an opening as a reservoir, and respectively connected to an upstream position of the pretreatment reaction chamber; and a liquid discharge channel connected to a downstream of the pretreatment reaction chamber; wherein the plurality of liquid injection channels and the liquid discharge channel respectively control liquid flow by a valve; and the nucleic acid amplification reaction region includes: a sample zone, a positive reaction zone, and a negative reaction zone, wherein the sample zone, the positive reaction zone, and the negative reaction zone respectively include a color reaction chamber; wherein the sample zone is connected to the pretreatment reaction chamber and include a reservoir and a valve to introduce the sample in the pretreatment reaction chamber and to produce a color reaction in the color reaction chamber of the sample zone.

Preferably, the liquid discharge channel further includes a capillary action power portion having a narrower channel and is connected to an opening as a waste reservoir.

Preferably, the sample zone, the positive reaction zone and the negative reaction zone respectively include an indicator to produce a color change in each of the color reaction chambers.

Preferably, the plurality of valves has an enlarged portion having a width greater than that of the plurality of channels on an upstream side of a liquid flow direction.

Preferably, the substrate is a glass substrate.

Preferably, the flexible material includes, but not limits to, for example, silicone (PDMS).

Preferably, heights of the plurality of valves are higher than those of the plurality of channels by about 200 μm to 250 μm.

Accordingly, the self-driven microfluidic chip for rapid influenza A detection of the present invention has one or more of the following advantages.

(1) The self-driven microfluidic chip of the present invention may integrate sample pretreatment (sample purification, extraction, etc.) and inspection analysis for a laboratory into one chip. It not only greatly reduces the required reagents and samples, but also simplifies the experimental process, reducing complex and time-consuming operations.

(2) The self-driven microfluidic chip of the present invention does not require additional instruments for liquid flow control by using the capillary action and the design of the hydrophobic valve, so that the doctor may directly perform the detection manually. Compared to the traditional rapid influenza diagnostic test chip, the chip of the present application has higher detection efficiency and sensitivity.

(3) The self-driven microfluidic chip of the present invention is suitable for all kinds of virus microorganism detections, and the magnetic beads may be tested for other kinds of viruses as long as the specific biological identification molecules and the primers for isothermal nucleic acid amplification of different viruses are combined. That is, applications thereof are in wide range.

### BRIEF DESCRIPTION OF THE DRAWINGS

FIG. 1 is a breakdown drawing showing an embodiment of a self-driven microfluidic chip of the present invention.

FIG. 2 is a structure schematic view showing a channel structure layer of an embodiment of a self-driven microfluidic chip of the present invention.

FIG. 3 is a schematic view showing the channel structure layer of the same embodiment.

FIG. 4A is a partial enlarged view showing portion (I) of FIG. 3.

FIG. 4B is a partial enlarged view showing portion (II) of FIG. 3.

FIG. 4C is a partial enlarged view showing portion (III) of FIG. 3.

FIG. 5 is an operation schematic view showing a valve of an embodiment of a self-driven microfluidic chip of the present invention.

FIG. 6 is a flow chart showing the operation of rapid influenza A diagnostic test by using an embodiment of a self-driven microfluidic chip of the present invention.

### DESCRIPTION OF THE PREFERRED EMBODIMENTS

The invention will be further described in detail by the following preferred embodiments and the accompanying drawings. It should be noted that the data, the size, and the structure disclosed in the following embodiments are used to facilitate the explanation of the technical features of the present invention, and are not intended to limit the aspects which may be implemented.

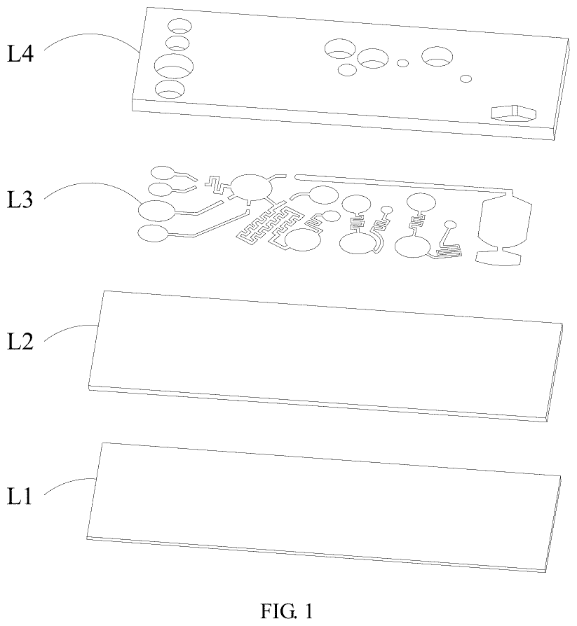

Please refer to FIG. 1, which depicts a breakdown drawing showing an embodiment of a self-driven microfluidic chip of the present invention. As shown, the self-driven microfluidic chip of the present invention includes a substrate L1, a hydrophobic layer L2 disposed on the substrate, a hydrophilic film layer L3 disposed on the hydrophobic layer L2, and a channel structure layer L4 disposed on the hydrophilic film layer L3. Wherein, the hydrophilic film layer L3 has a pattern corresponding to the structure of the channel structure layer L4, and forms a disconnected area corresponding to locations of valves to make the valves hydrophobic. In the present embodiment, the substrate L1 may be a glass substrate or other transparent hard plastic material suitable for laying the hydrophobic layer L2. The channel structure layer L4 is formed of a flexible material, such as a transparent soft plastic material, preferably using a silicone (PDMS), so that the valves may be opened by direct pressing to allow liquid to circulate. The self-driven microfluidic chip of the present embodiment has a length of about 75 to 80 mm and a width of about 25 to 30 mm, but the present invention is not limited thereto.

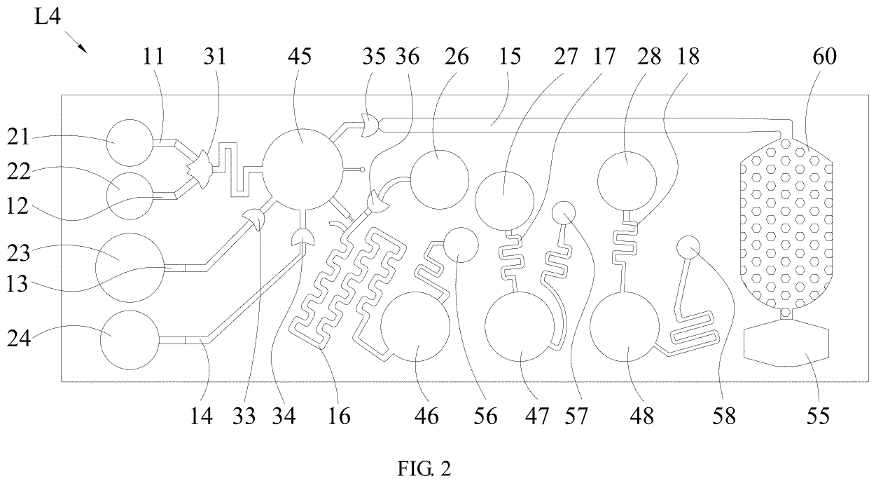

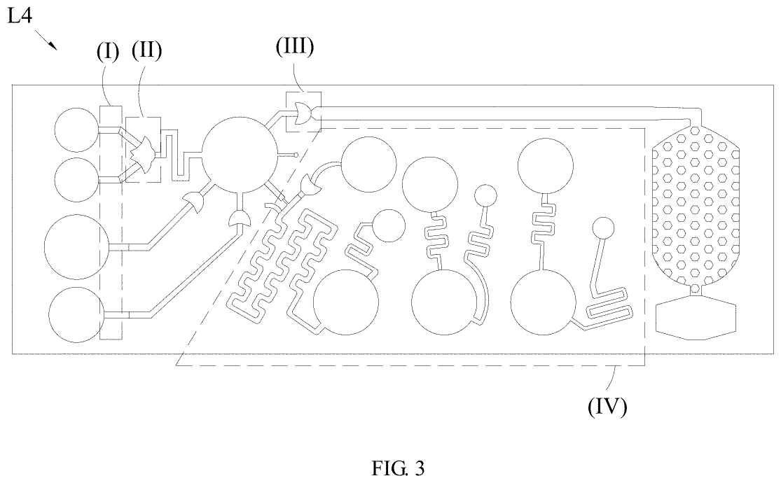

Please refer to FIGS. 2 and 3, which depict structure schematic views showing a channel structure layer of an embodiment of a self-driven microfluidic chip of the present invention. The structure of the channel structure layer L4 of the present embodiment includes: a plurality of channels (11 to 18), a plurality of valves (31, 33 to 36) disposed in the channels, a plurality of reaction chambers (45 to 48), and a plurality of openings which includes inlets (21 to 24 and 26 to 28) and outlets (55-58). Wherein, the inlets (21 to 24 and 26 to 28) located on the front end of each channel may be used as a reservoir for injecting samples or reagents, and the outlets (55-58) located on the rear end of each channel may be used as vent holes or waste reservoir to make the liquid in the channels automatically advance by capillary action so as to achieve a self-driven effect.

As shown in FIG. 3, the structure of the channel structure layer L4 may be further divided into a sample pretreatment region (portions other than portion IV) for purifying and lysing virus in a sample, and a nucleic acid amplification reaction region (portion IV) for nucleic acid amplification by an isothermal nucleic acid amplification method. As shown in FIG. 2, the sample pretreatment region includes a pretreatment reaction chamber 45; a plurality of liquid injection channels, such as a first channel 11, a second channel 12, a third channel 13, and a fourth channel 14, respectively connected to an upstream position of the pretreatment reaction chamber 45; and a fifth channel 15 connected to a downstream position of the pretreatment reaction chamber 45 as a liquid discharge channel The plurality of liquid injection channels described above respectively have an opening as a reservoir, such as a sample reservoir 21 of the first channel 11, the magnetic beads reservoir 22 of the second channel 12, the cleaning liquid reservoir 23 of the third channel 13, and the lysing liquid reservoir 24 of the fourth channel 14. Wherein, the sample reservoir 21 and the magnetic beads reservoir 22 may respectively be used as the positions for injecting the sample and the magnetic beads for virus purification, and the first channel 11 and the second channel 12 may converge at a confluence valve 31. The confluence valve 31 may simultaneously control the liquid flow of the first channel 11 and the second channel 12 to make the sample and the magnetic beads start mixing before entering the pretreatment reaction chamber 45. In addition, the channel after converging is formed into a serpentine shape having a curve, which may further improve the mixing effect, thus enhancing the detection accuracy. Further, the cleaning liquid reservoir 23 and the lysing liquid reservoir 24 may be respectively injected with the cleaning liquid for removing impurities and the lysing liquid for virus lysis, and the opening and closing of the channels may be controlled by a cleaning liquid valve 33 and a lysing liquid valve 34, respectively. Finally, the fifth channel 15 may be opened by a waste liquid valve 35 located at a downstream position of the pretreatment reaction chamber 45 so that the waste liquid in the pretreatment reaction chamber 45 may flow to a waste reservoir 55. A position of the fifth channel 15 before reaching the waste reservoir 55 may further include a capillary action power portion 60 having a narrower channel as a pump for accelerating capillary action, or may accelerate the collection of the waste liquid with filter paper after the waste liquid flowing to the waste reservoir 55.

On the other hand, the nucleic acid amplification reaction region includes a sample zone, a positive reaction zone, and a negative reaction zone, wherein the sample zone, the positive reaction zone, and the negative reaction zone respectively has a channel (16 to 18) separated from one another, and respectively has a color reaction chamber (46 to 48). A sixth channel 16 of the sample zone is connected to the pretreatment reaction chamber 45 and includes a reaction solution reservoir 26 containing isothermal nucleic acid reaction solution (including magnesium ion indicator) and a reaction solution valve 36. The reaction solution of the reaction solution reservoir 26 and the sample of the pretreatment reaction chamber 45 may be introduced into the sixth channel 16 when the reaction solution valve 36 is pressed. The color reaction is carried on in the sample color reaction chamber 46. The sixth channel 16 may also form a serpentine shape to improve the mixing effect of the sample and the reaction solution.

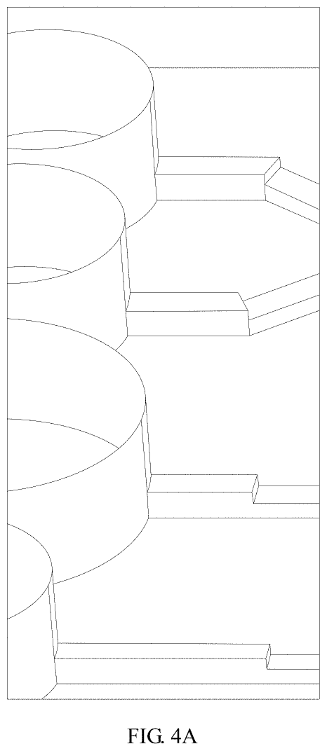

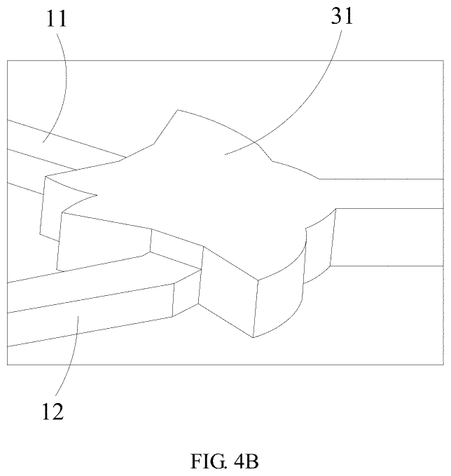

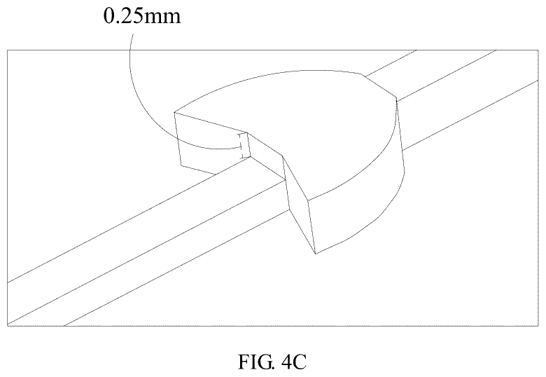

Next, please refer to FIGS. 4A to 4C, which depict partially enlarged views showing portions (I) to (III) of FIG. 3. As shown in FIG. 4A, the channel near the reservoir may have a step-difference to prevent the liquid in the channel from flowing back into the reservoir. As shown in FIGS. 4B and 4C, the height of each valves in the thickness direction of the channel structure layer is higher than the height of the channel, for example, about 200 μm to 250 μm higher than the channel, to control the liquid flow by the capillary action principle so as to prevent the liquid from automatically passing through the channel before the valve is pressed. Further, each valve may have an enlarged portion having a width greater than that of the channel on the upstream side of the liquid flow direction to further prevent the liquid from automatically passing through. Each valve is narrowed to form an arrow-like shape on the downstream side of the liquid flow direction, so that the liquid is easier to push forward. Besides, as shown in FIG. 4B, the channel at the downstream side of the confluence valve 31 may be higher than the channel at the upstream side to accelerate the liquid flowing into the following reservoir and to reduce the flow rate of the liquid, thus improving the mixing of the sample and the magnetic beads.

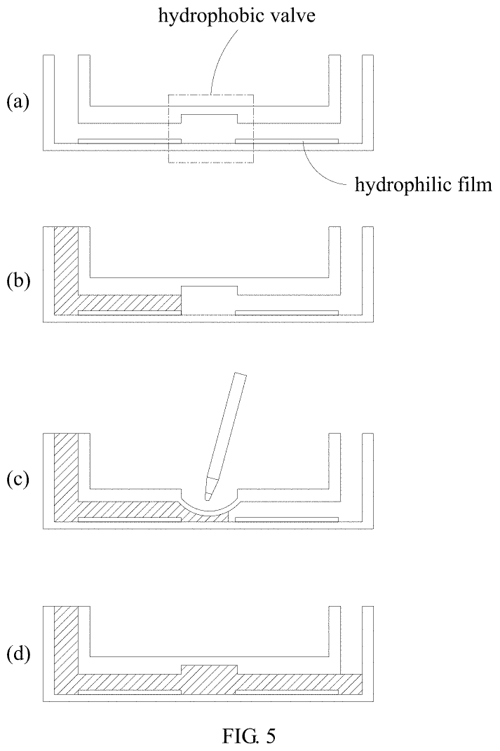

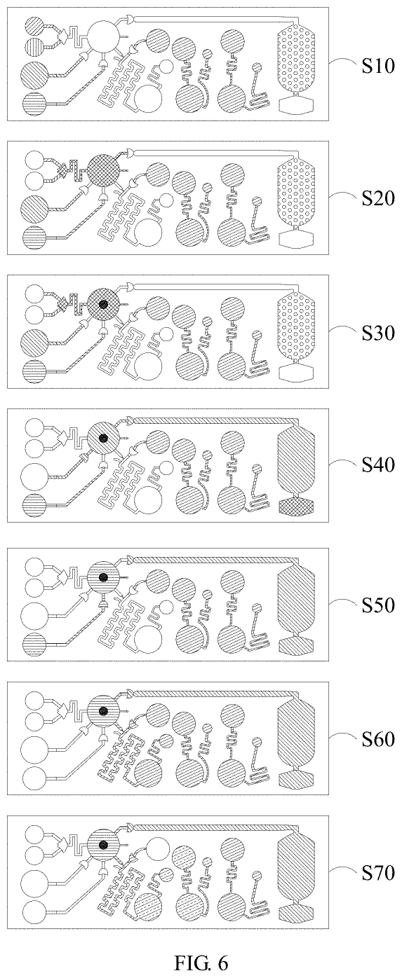

Please refer to FIG. 5, which depicts an operation schematic view showing a valve of an embodiment of a self-driven microfluidic chip of the present invention. As shown in part (a) of FIG. 5, the valve of the present invention is a disconnected area of the hydrophilic film layer, which is hydrophobic and has a height greater than that of the channel, so that as shown in part (b) of FIG. 5, when the liquid is injected, the liquid is blocked in front of the valve. When the valve is pressed with an external force as shown in part (c) of FIG. 5, the liquid may flow through the valve by capillary action and maintain the valve in an open state, as shown in part (d) of FIG. 6. Therefore, a user only needs to press the valve once to pass the liquid without additional driving force.

Please refer to FIG. 6, which depicts a flow chart showing the operation of rapid influenza A diagnostic test by using an embodiment of a self-driven microfluidic chip of the present invention. The diagnostic method of the present invention utilizes an isothermal nucleic acid amplification method to make a nucleic acid of a virus react so as to diagnose the presence of influenza A virus. The detailed steps may be explained as follows with the configuration of the structure of the self-driven microfluidic chip of FIG. 2.

First, the sample and the reagent are separately injected into the respective reservoirs (S10). In the present embodiment, the sample reservoir 21 is injected with the sample; the magnetic beads reservoir 22 is injected with magnetic beads conjugated with a specific aptamer for H1N1; the cleaning liquid reservoir 23 is injected with the cleaning liquid; the lysing liquid reservoir 24 is injected with the reagent for lysising virus; the reaction solution reservoir 26 is injected with the isothermal nucleic acid reaction solution (including magnesium ion indicator); the positive reaction reservoir 27 is injected with the isothermal nucleic acid reaction solution (including magnesium ion indicator) and the positive sample; and the negative reaction reservoir 28 is injected with the isothermal nucleic acid reaction solution (including magnesium ion indicator) and the negative sample. Here, the positive reaction reservoir 27 and the negative reaction reservoir 28 directly flow into the respective color reaction chambers (47 and 48) to wait for reaction.

Next, the confluence valve 31 is pressed to mix the sample pending to test of the sample reservoir 21 with the magnetic beads of the magnetic beads reservoir 22 and enter the pretreatment reaction chamber 45 (S20). Here, if the sample has H1N1 virus, it will be captured by the magnetic beads.

The self-driven microfluidic chip of the present invention is placed on the magnet to fix the magnetic beads in the pretreatment reaction chamber 45 (S30), and then the cleaning liquid valve 33 and the waste liquid valve 35 are pressed to make the cleaning liquid of the cleaning liquid reservoir 23 pass through the pretreatment reaction chamber 45 so as to wash the impurities other than the virus away (S40), and discharges the waste liquid to the waste reservoir 55. After the impurities are removed, the lysing liquid valve 34 is pressed to make the virus lysis reagent of the lysis liquid reservoir 24 enter the pretreatment reaction chamber 45 to lysis the virus (S50) in order to extract the nucleic acid of the virus.

Then, the reaction solution valve 36 is pressed to make the isothermal nucleic acid reaction solution of the reaction solution reservoir 26 flow into the sixth channel 16, while the liquid in the pretreatment reaction chamber 45 is pushed by the capillary action to enter the sixth channel 16 together, in order to mix the isothermal nucleic acid reaction solution with the liquid in the pretreatment reaction chamber 45 and inject into the sample color reaction chamber 46. The self-driven microfluidic chip is heated (S60) to perform isothermal nucleic acid amplification. This embodiment is heated at about 60 to 80° C. for about 15 to 30 minutes.

Finally, after the color reaction is completed, the color of the sample color reaction chamber 46, the color of the positive color reaction chamber 47, and the color of the negative color reaction chamber 48 are compared to determine whether the sample is positive or negative (S70) to diagnose whether the H1N1 virus exists in the sample or not. Here, the user may confirm the color change with the naked eye, or by using the optical sensor to obtain accurate data of the RGB color, so as to determine the color of the sample color reaction chamber 46 is closer to a positive color or negative color.

The above embodiment exemplifies the steps of the user to operate manually, but the present invention is not limited thereto. For example, the above steps may also be integrated into an automatic system or instrument to save time and staff required for the experiment.

Further, although the above embodiment exemplifies the detection of the H1N1 virus by the self-driven microfluidic chip of the present invention, the present invention is not limited thereto. For example, according to different detection objects or test types, the self-driven microfluidic chip of the present invention may be adjusted without additional changed chip design, such as changing the specific identification molecules (such as antibodies) on the magnetic beads and the types of reagents, etc. Further, the above embodiments have been described in detail with respect to the arrangement and use of the respective reservoirs, valves, and the like, but the terms used in the above embodiments are for illustrative purposes only and are not intended to limit the actual implementation of the present invention. Therefore, the user may also make changes according to the detection needs, such as changing the cleaning liquid reservoir to a reservoir of other reagents, etc., but the present invention is not limited thereto.

Accordingly, the self-driven microfluidic chip disclosed in the present invention may integrate sample pretreatment (sample purification, extraction, etc.) and inspection analysis into one chip, which may not only greatly reduce the required reagents and samples, but also simplify the experimental process to reduce complex and time-consuming operations. In addition, the self-driven microfluidic chip of the present invention utilizes the capillary action principle and the design of the hydrophobic valve, and does not require additional instruments for controlling liquid flow, so that the doctor may directly perform the detection manually. Compared to the traditional rapid influenza diagnostic test chip, the present invention has higher detection efficiency and sensitivity.

In summary, the preferred embodiments of the present invention have been disclosed above, but are not intended to limit the present invention. It will be understood by those of ordinary skill in the art that equivalent changes or modification may be made therein without departing from the spirit and scope of the present invention as defined by the claims.

What is claimed is:

1. A self-driven microfluidic chip, comprising:
a substrate;
a hydrophobic layer disposed on the substrate;
a hydrophilic film layer disposed on the hydrophobic layer; and
a channel structure layer disposed on the hydrophilic film layer, a structure of the channel structure layer comprising a plurality of channels, a plurality of valves disposed in the plurality of channels, a plurality of reaction chambers, and a plurality of openings;
wherein the hydrophilic film layer has a pattern corresponding to the structure of the channel structure layer, and forms a disconnected area corresponding to locations of the plurality of valves to make the plurality of valves hydrophobic, and
the channel structure layer is formed of a flexible material, and heights of the plurality of valves are higher than those of the plurality of channels in a thickness direction of the channel structure layer in order to control liquid flow by pressing the plurality of valves.

2. The self-driven microfluidic chip according to claim 1, wherein the structure of the channel structure layer is further divided into a sample pretreatment region for purifying and lysing virus in a sample, and a nucleic acid amplification reaction region for nucleic acid amplification by an isothermal nucleic acid amplification method.

3. The self-driven microfluidic chip according to claim 2, wherein
the sample pretreatment region comprises:
a pretreatment reaction chamber;
a plurality of liquid injection channels respectively having an opening as a reservoir, and respectively connected to an upstream position of the pretreatment reaction chamber; and
a liquid discharge channel connected to a downstream of the pretreatment reaction chamber;
wherein the plurality of liquid injection channels and the liquid discharge channel respectively control liquid flow by a valve; and
the nucleic acid amplification reaction region comprises: a sample zone, a positive reaction zone, and a negative reaction zone, wherein the sample zone, the positive reaction zone, and the negative reaction zone respectively comprise a color reaction chamber;
wherein the sample zone is connected to the pretreatment reaction chamber and comprises a reservoir and a valve to introduce the sample in the pretreatment reaction chamber and to produce a color reaction in the color reaction chamber of the sample zone.

4. The self-driven microfluidic chip according to claim 3, wherein the liquid discharge channel further comprises a capillary action power portion having a narrower channel and is connected to an opening as a waste reservoir.

5. The self-driven microfluidic chip according to claim 3, wherein the sample zone, the positive reaction zone, and the negative reaction zone respectively comprise an indicator to produce a color change in each of the color reaction chambers.

6. The self-driven microfluidic chip according to claim 1, wherein the plurality of valves have an enlarged portion having a width greater than that of the plurality of channels on an upstream side of a liquid flow direction.

7. The self-driven microfluidic chip according to claim 1, wherein the substrate is a glass substrate.

8. The self-driven microfluidic chip according to claim 1, wherein the flexible material comprises silicone (PDMS).

9. The self-driven microfluidic chip according to claim 1, wherein heights of the plurality of valves are higher than those of the plurality of channels by about 200 μm to 250 μm.
